(19) United States
(12) Patent Application Publication
(10) Pub. No.: US 2002/0034655 A1
(43) Pub. Date: Mar. 21, 2002

(54) Organic electroluminescence element

(76) Inventors: Teruichi Watanabe, Tsurugashima-shi (JP); Shin Kawami, Tsurugashima-shi (JP); Takeo Wakimoto, Tsurugashima-shi (JP)

Correspondence Address: SUGHRUE, MION, ZINN,, MACPEAK & SEAS, PLLC, 2100 PENNSYLVANIA AVENUE, N.W., WASHINGTON, DC, 20037-3213, US

(21) Appl. No.: 09/844,679

(22) Filed: Apr. 30, 2001

(30) Foreign Application Priority Data
Apr. 28, 2000 (JP) 2000-130694

(51) Int. Cl. H05B 33/14

(52) U.S. Cl. 428/690; 428/917; 313/504; 313/506; 257/102

(57) ABSTRACT

An organic electroluminescence element has a laminate of an anode, a hole injecting layer made of an organic compound and laminated in contact with said anode, a light emitting layer made of an organic compound, an electron transport layer made of an organic compound, and a cathode. The light emitting layer comprises of a carbasol compound as a main component and includes a iridium complex compound at a concentration of 0.5 wt % to 8 wt %.

### BACKGROUND OF THE INVENTION 1. Field of the Invention

The present invention relates to an organic electroluminescence element (hereinafter also referred to as the “organic EL element”) which utilizes the electroluminescence (hereinafter also referred to as the “EL”) of organic compounds which emit light in response to a current injected thereinto, and has a light emitting layer formed of a laminate of such materials.

2. Description of the Related Art

Generally, each of organic EL elements constituting a display panel using organic materials comprises an anode as a transparent electrode, a plurality of organic material layers including an organic light emitting layer, and a cathode comprised of a metal electrode, which are laminated as thin films in this order on a glass substrate as a display surface. The organic material layers include, in addition to the organic light emitting layer, a layer of a material having the hole transport capability such as a hole injecting layer, a hole transport layer or the like, a layer of a material having the electron transport capability such as an electron transport layer, an electron injecting layer, or the like. Organic EL elements comprising these layers have also been proposed. The electron injecting layer also contains an inorganic compound.

When an electric field is applied to the laminate organic EL element including an organic light emitting layer and an electron or hole transport layer, holes are injected from the anode, at the same time electrons are injected from the cathode. The electrons and the holes are recombined in the organic light emitting layer to form excitons. The organic EL element utilizes light which is emitted when the excitons return to a ground state, i.e., the luminescence. Conventionally, a fluorescent material has been frequently used in the light emitting layer, and in some cases, a pigment may be doped into the light emitting layer, for improving the efficiency of light emission and stably driving the element.

In recent years, utilization of a phosphorescent material in the light emitting layer of the organic EL element has been proposed in addition to the fluorescent material (D. F. O'Brien and M. A. Baldo et al “Improved energy transfer in electrophosphorescent devices” Applied Physics letters Vol. 74 No. 3, pp 442-444, Jan. 18, 1999; M. A. Baldo et al “Very high-efficiency green organic light-emitting devices based on electrophosphorescence” Applied Physics letters Vol. 75 No. 1, pp 4-6, Jul. 5, 1999; Tetsuo Tsutsui et al “High quantum efficiency in organic light-emitting devices with Iridium-complex as a triplet emissive center” JJAP Vol. 38(1999) No. 12B in press, pp ?-?). Organic materials are excited when carrier electrons or holes injected by an electric field are recombined, and emit light when they fall down to a ground state. In this event, excited organic molecules take a singlet excited state of high energy (electrons exhibit reverse spin) and a triplet excited state of low energy (electrons exhibit normal spin). The luminescence is classified according to the duration of afterglow after the supply of excitation energy is stopped, and generally classified into fluorescence when the afterglow lasts for several nano seconds and phosphorescence when the afterglow lasts for several micro seconds. But this classification is not exact strictly. In the phosphorescence, light emission duration decreases in proportion to the elevation in ambient temperature. On the other hand, in the fluorescence, the duration of afterglow does not depend on the temperature and the afterglow process extremely rapid.

In recent studies on the organic EL elements, organic phosphorescent materials have increasingly drawn attention as materials for improving a light emission efficiency. Generally, the light emission process of phosphorescence involves excitation of molecules from a ground state to an excited state, and a subsequent non-irradiate transition from a singlet state to a triplet state, referred to as intersystem crossing. The phosphorescence refers to the luminescence from the triplet state to the ground state, while the afterglow corresponding to a transition of the triplet state to the singlet state and to the ground state is referred to as delay fluorescence. In this manner, the spectrum of organic phosphorescence is always different from the spectrum of general fluorescence. This is because the two cases differ in the light emitting state (the singlet state and the triplet state) and common in the final ground state. For example, in anthracene, phosphorescence is red in a range of 670 to 800 nm, and fluorescence is blue in a range of 470 to 480 nm.

It is anticipated that a high light emission efficiency is achieved when the singlet state and the triplet state of the organic phosphorescent material are utilized in a light emitting layer of an organic EL element. The triplet is utilized because it is thought that excitons of singlet and triplet excited states are produced at a ratio of 1:3 due to a difference in the spin multiplicity when electrons and holes are re-combined in the organic EL element, so that the achievement of a light emission efficiency three times higher than that of a fluorescence-based element is expected.

The provision of a light emitting layer made of an organic phosphorescent material may be effective in increasing the light emission efficiency of the organic EL element, and moreover the lifetime of organic EL elements must be further extended. Therefore, a need exists for an organic EL element, which exhibits a high light emission efficiency, capable of continuously emitting light at a high luminance with a less current.

### OBJECT AND SUMMARY OF THE INVENTION

It is an object of the present invention to provide an organic EL element which provides for extension of lifetime.

An organic EL element according to the present invention has a laminate of an anode, a hole injecting layer made of an organic compound and laminated in contact with the anode, a light emitting layer made of an organic compound, an electron transport layer made of an organic compound and a cathode, wherein said light emitting layer comprises of a carbasol compound as a main component and includes a iridium complex compound at a concentration of 0.5 wt % to 8 wt %.

In one aspect of the organic EL element according to the invention, said iridium complex compound is tris(2-phenylpyridine).

In another aspect of the organic EL element according to the invention, said carbasol compound is 4,4′-N,N′-dicarbasol-biphenyl.

In a further aspect of the organic EL element according to the invention, said carbasol compound is 4,4′,4″-tris(N-carbasolyl)triphenylamine.

In a still further aspect of the organic EL element according to the invention, the element further comprises one or more layers made of a material including an organic compound and having a hole transport capability, disposed between said anode and said light emitting layer.

In another aspect of the organic EL element according to the invention, the element further comprises an electron injecting layer disposed between said cathode and said electron transport layer.

In a further aspect of the organic EL element according to the invention, the element further comprises a hole blocking layer made of an organic compound between said light emitting layer and said electron transport layer.

In a still further aspect of the organic EL element according to the invention, said light emitting layer includes an electron transport material having an ionization potential smaller than said hole blocking layer.

### BRIEF DESCRIPTION OF THE DRAWINGS

FIGS. 1 through 5 are diagrams each illustrating the structure of an organic EL element;

FIG. 6 is a graph showing a luminance characteristic versus a driving time of an organic EL element according to the present invention; and

FIG. 7 is a graph showing a luminance half-life period characteristic of organic EL elements according to the present invention with respect to a concentration of Ir(PPY)3 in the light emitting layer made of CBP.

### DETAILED DESCRIPTION OF THE PREFERRED EMBODIMENT

An embodiment of the present invention will hereinafter be described with reference to the accompanying drawings.

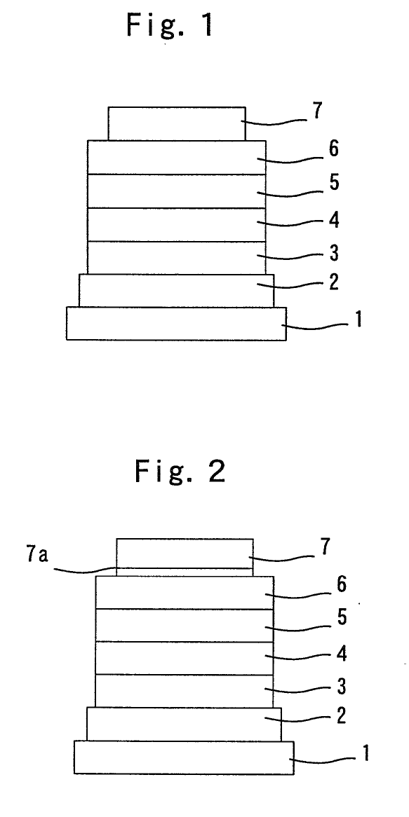

As illustrated in FIG. 1, the organic EL element is comprised of a transparent anode 2; a hole transport layer 3 made of an organic compound; a light emitting layer 4 made of an organic compound; an electron transport layer 6 made of an organic compound; and a cathode 7 made of a metal, laminated on a transparent electrode 1 made of glass or the like.

In addition to the foregoing structure, another organic EL element may have a structure which includes an electron injecting layer 7a laminated or deposited as a thin film between the electron transport layer 6 and the cathode 7, as illustrated in FIG. 2.

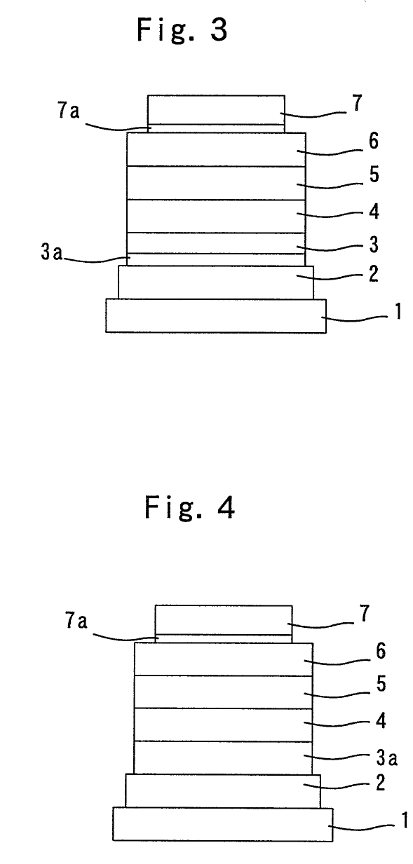

Moreover, in addition to the structure illustrated in FIG. 2, a further organic EL element may have a structure which includes a hole injecting layer 3a laminated or deposited as a thin film between the transparent anode 2 and the hole transport layer 3, as illustrated in FIG. 3.

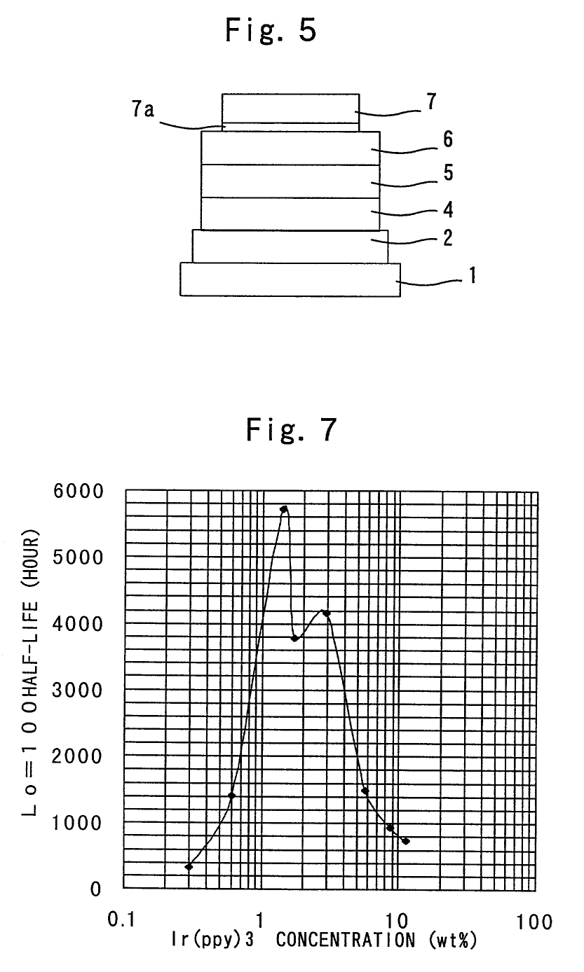

Alternatively, provided that the light emitting layer 4 is made of a light emitting material having the hole transport capability, the hole transport layer 3 may be omitted from the organic EL element structures illustrated in FIGS. 1 to 3. For example, as illustrated in FIG. 4, an organic EL element may have a structure comprised of an anode 2, a thermally stable organic hole injecting layer 3a, a light emitting layer 4, a hole blocking layer 5, an electron transport layer 6 and a cathode 7 which are deposited in this order on a substrate 1. Also as illustrated in FIG. 5, an organic EL element may have a structure comprised of an anode 2, a light emitting layer 4, a hole blocking layer 5, an electron transport layer 6 and a cathode 7 deposited in this order on a substrate 1.

In these embodiments, used as the cathode 1 may be a metal which has a small work function, for example, lithium, barium, aluminum, magnesium, indium, silver, alloys thereof, or the like, and a thickness in a range of approximately 100 to 5,000 angstroms. Also, used as the anode 2 may be a conductive material which has a large work function, for example, indium tin oxide (hereinafter abbreviated as “ITO”) or the like, and a thickness in a range of approximately 300 to 3,000 angstroms, or gold of approximately 800 to 1,500 angstroms in thickness. It should be noted that when gold is used as an electrode material, the electrode is translucent. Either the cathode or the anode may be transparent or translucent.

In the embodiments, an organic phosphorescent material, which is a guest component included in the light emitting layer 4 is, for example, tris(2-phenylpyridine) iridium (which is referred to as “Ir(PPY)3” in this paper), represented by the following chemical formula (1).

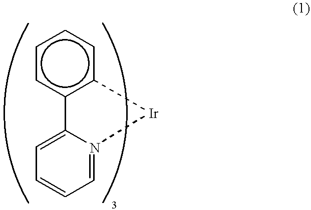

In the embodiments, a carbasol compound material, which is a host material as a major component included in the light emitting layer 4 is, for example, 4,4′-N,N′-dicarbasol-biphenyl (which is abbreviated as “CBP” in this paper), represented by the following chemical formula (2). Also 4,4′,4″-tris(N-carbasolyl)triphenylamine, represented by the following chemical formula (3) may be used for the host material in the light emitting layer 4 of the organic EL element.

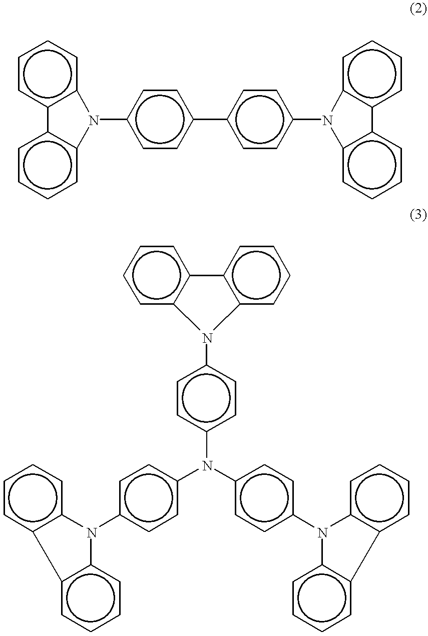

In the embodiment, a material for the hole blocking layer 5 laminated between the light emitting layer 4 and the electron transport layer 6 is an electron transport material having the electron transport capability, e.g., selected from materials represented by the following chemical formulae (4) to (25). Alternatively, the hole blocking layer 5 may be a mixed layer made of two or more kinds of electron transport materials mixed by coevaporation or the like, and deposited. Electron transport materials having the electron transport capability may be selected from materials represented by the following chemical formulae (4) to (25). An electron transport material of the hole blocking layer is selected to be a material whose ionization potential is larger than the ionization potential of the light emitting layer.

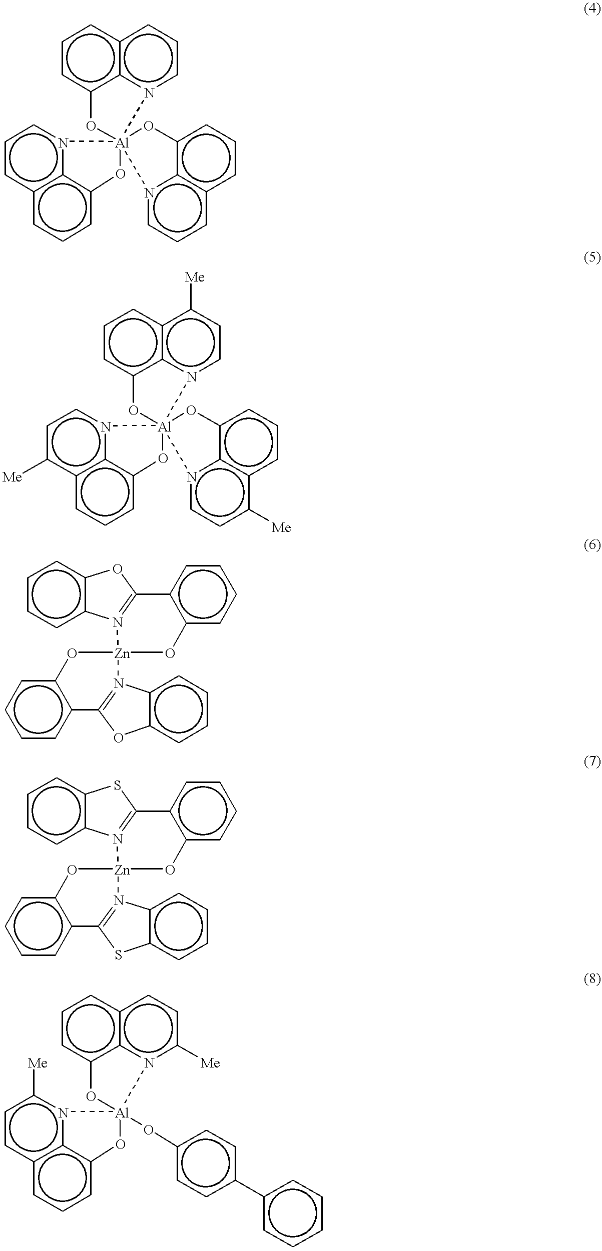

In the embodiments, the component contained in the light emitting layer is a hole transport material having the hole transport capability represented by the following formulae (26) to (44), for example.

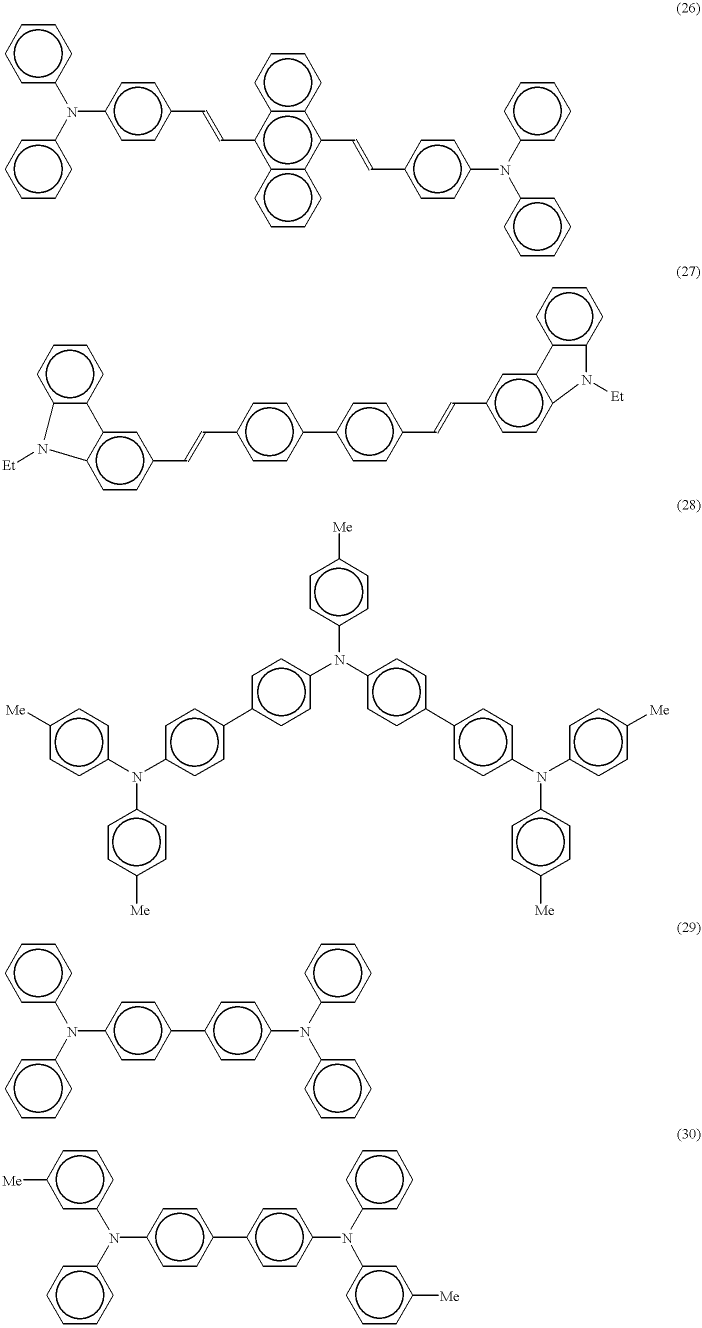

In the foregoing chemical formulae, Me represents a methyl group; Et, an ethyl group; Bu, a butyl group; and t-Bu, a tertiary class butyl group. The light emitting layer 4 may contain materials other than those shown in the foregoing chemical formulae. Also, the light emitting layer may be doped with a fluorescent material or a phosphorescent material having a high fluorescence quantum efficiency.

In the embodiments, a material for the hole transport layer 3 may be selected, for example, from materials having the hole transport capability as represented by the foregoing chemical formulae (26) to (44). In addition, the hole transport layer disposed on the hole injecting layer may be formed by coevaporation as a mixed layer comprised of a plurality of materials having the hole transport capability, made of organic compounds, and additionally one or more mixed layers may be provided. In this way, one or more layers made of an organic compound having the hole transport capability can be disposed between the hole injecting layer and the light emitting layer as a hole injecting layer or a hole transport layer.

Organic EL elements were specifically made for evaluating their characteristics.

### EXAMPLE

The respective thin films were laminated on a glass substrate formed with an anode made of ITO having a thickness of 110 nm by a vacuum deposition method at the degree of vacuum of 5.0×10⁻⁶ Torr.

First, 4,4′-bis[N-(1-naphthyl)-N-phenylamino]-biphenyl (hereinafter abbreviated as “NPB”) represented by the above formula (42) was formed in a thickness of 25 nm on the ITO as a hole injecting layer at a deposition rate of 3 A/sec.

Next, on each hole injecting layer CBP represented by the above formula (2) and Ir(PPY)3 represented by the above formula (1) were coevaporated from different evaporation sources to form a light emitting layer of 40 nm in thickness. In this event, there were prepared many sample substrates having concentrations of Ir(PPY)3 in the respective light emitting layer 11.4 wt %, 8.6 wt %, 5.7 wt %, 2.9 wt %, 1.7 wt %, 1.4 wt %, 0.6 wt %, and 0.3 wt %, respectively.

Next, on each light emitting layer, 2,9-dimethyl-4,7-diphenyl-1,10-phenanthroline (so-called BCP) represented by the above formula (17) was vapor deposited to form a hole blocking layer of 10 nm in thickness.

Subsequently, on the hole blocking layer, tris-(8-hyroxyquinolinealuminum) (so-called Alq3) represented by the above formula (4) was deposited as an electron transport layer in a thickness of 40 nm at a deposition rate of 3 Å/sec.

Further, on the electron transport layer, lithium oxide (Li₂O) was deposited as an electron injecting layer in a thickness of 5 Å at a deposition rate of 0.1 Å/sec, and aluminum (Al) was laminated on the electron injecting layer as an electrode in a thickness of 100 nm at a rate of 10 Å/sec. In this way, organic light emitting elements were completed.

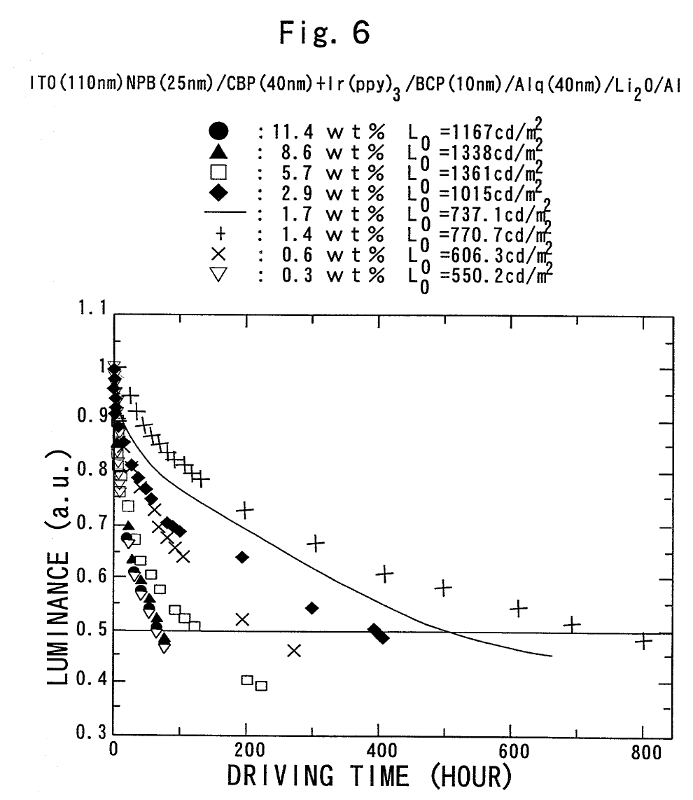

The resultant elements emitted light from the light emitting layer including Ir(PPY)3 having concentrations of 11.4 wt %-0.3 wt % respectively. When elements created as described were driven with a regulated current of 2.5 mA/mm², values of initial luminance Lo were measured respectively. Further changes of luminance were observed for each organic light emitting element. The following Table shows concentrations of Ir(PPY)3, values of initial luminance Lo, half-life periods of luminance, and normalized half-life periods of luminance of the resultant organic EL elements. FIG. 6 shows a luminance half-life period characteristic of the resultant organic EL elements. The normalized half-life periods was calculated with respected to initial luminance Lo=100.

| | INITIAL | | Lo = 100 |
|---|---|---|---|
| CONCENTRATION | LUMINANCE | HALF-LIFE | HALF-LIFE |
| (wt %) | (cd/m²) | (HOUR) | (HOUR) |
| 11.4 | 1167.0 | 63 | 735.21 |
| 8.6 | 1338.0 | 70 | 936.6 |
| 5.7 | 1361.0 | 110 | 1497.1 |
| 2.9 | 1015.0 | 409 | 4151.35 |
| 1.7 | 737.1 | 512 | 3773.44 |
| 1.4 | 770.7 | 742 | 5720.82 |
| 0.6 | 606.3 | 234 | 1418.04 |
| 0.3 | 550.2 | 60 | 330 |

As seen from the Table, the initial luminance Lo of the organic EL element depends on the concentration of Ir(PPY)3 in the light emitting layer. It is also found that the luminance half-life period of the organic EL element having the light emitting layer containing Ir(PPY)3 depends on the concentration of Ir(PPY)3 in the light emitting layer of the element. In other words, too high or too low concentration of Ir(PPY)3 in the light emitting layer is not suitable for increasing the luminance half-life period of the element. In general, the electric current characteristic of the organic EL element exhibits luminance increasing in substantially proportion as supplied current, and the lifetime of EL element (the luminance half-life period) and the driving current value at measurements of the lifetime are in substantially inverse proportion to each other. Thus, the inventors have estimated a pertinent concentration for Ir(PPY)3 in the light emitting layer. In this case, the luminance half-life periods at the time that an initial luminance vale 100 cd/m² was obtained were calculated on the basis of the above experienced data in view of conditions of actual products of organic EL devices. The mathematical products of 1/100 of the experienced initial luminance of the element and its luminance half-life period, as values of Lo=100 half-life, are described in the above Table.

FIG. 7 shows the characteristics of Lo=100 half-life with respect to the concentration of Ir(PPY)3 in the light emitting layer. As seen from FIG. 7, actually, it is preferable in view of necessary luminance half-life period of 1000 hours or more that the concentration of Ir(PPY)3 in the light emitting layer is established in the range from 0.5 wt % to 8 wt %. Moreover, the improvement of lifetime of the element may not be expected except the range from 0.5 wt % to 8 wt % of the concentration of Ir(PPY)3 in CBP. In the full width at half maximum ranging from 0.8 wt % to 4 wt % within the characteristics in the shown in FIG. 7, the lifetime of the organic EL element is achieved at 3000 hours or more and the luminance half-life period is remarkably improved.

Furthermore, instead of CBP, 4,4′,4″-tris(N-carbasolyl)triphenylamine was used for the host material in the light emitting layer of the organic EL element and resulting in the similar effect to the above embodiment. It was therefore confirmed that the concentration of iridium complex compound in the light emitting layer of the carbasol compound ranging from 0.5 wt % to 8 wt % provides the effectiveness in prolonging lifetime of the organic EL element.

As described above, according to the present invention, the light emitting layer comprises of a carbasol compound as a main component and includes a iridium complex compound at a concentration of 0.5 wt % to 8 wt %, thereby providing an organic EL element which can emit light for a long time period.

It is understood that the foregoing description and accompanying drawings set forth the preferred embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese Patent Application No. 2000-130694 which is hereby incorporated by reference.

What is claimed is:

1. An organic electroluminescence element having a laminate of an anode, a hole injecting layer made of an organic compound and laminated in contact with said anode, a light emitting layer made of an organic compound, an electron transport layer made of an organic compound, and a cathode, wherein said light emitting layer comprises of a carbasol compound as a main component and includes a iridium complex compound at a concentration of 0.5 wt % to 8 wt %.

2. An organic electroluminescence element according to claim 1, wherein said iridium complex compound is tris(2-phenylpyridine).

3. An organic electroluminescence element according to claim 2, wherein said carbasol compound is 4,4′-N,N′-dicarbasol-biphenyl.

4. An organic electroluminescence element according to claim 2, wherein said carbasol compound is 4,4′,4″-tris(N-carbasolyl)triphenylamine.

5. An organic electroluminescence element according to claim 1, further comprising one or more layers made of a material including an organic compound and having a hole transport capability, disposed between said anode and said light emitting layer.

6. An organic electroluminescence element according to claim 1, further comprising an electron injecting layer disposed between said cathode and said electron transport layer.

7. An organic electroluminescence element according to claim 1 further comprising a hole blocking layer made of an organic compound between said light emitting layer and said electron transport layer.

8. An organic electroluminescence element according to claim 7, wherein said light emitting layer includes an electron transport material having an ionization potential smaller than said hole blocking layer.
